(19) United States
(12) Patent Application Publication
(10) Pub. No.: US 2026/0061318 A1
(43) Pub. Date: Mar. 5, 2026

(54) NON-TRANSITORY COMPUTER-READABLE STORAGE MEDIUM, INFORMATION PROCESSING SYSTEM, AND INFORMATION PROCESSING METHOD

(71) Applicant: NINTENDO CO., LTD., Kyoto (JP)

(72) Inventors: Shawn P. WINGLER, Austin, TX (US); Benjamin E. JACKSON, Austin, TX (US); Jose M. GUERRA CHAPA, Austin, TX (US)

(21) Appl. No.: 19/306,653

(22) Filed: Aug. 21, 2025

(51) Int. Cl. A63F 13/56; A63F 13/525

(52) U.S. Cl. CPC A63F 13/56; A63F 13/525

(57) ABSTRACT

A gaming device (100) has a mode switching unit (112), a player character control unit (114) that controls a player character in a virtual space, a virtual camera control unit (113) that controls a virtual camera, and a vehicle object control unit (115) that controls a vehicle object in the virtual space. The virtual camera control unit (113) controls the virtual camera to generate a first person perspective image in the first mode, and controls the virtual camera to generate a third person perspective image in the second mode. The player character control unit (114) and/or the virtual camera control unit (113) causes the facing direction of the player character to be set according to the facing direction of the virtual camera when the player character disembarks from the vehicle object.

### FIELD

The present disclosure relates to an information processing system and an information processing method for executing a game in which a virtual space is provided, and a non-transitory computer-readable storage medium storing instructions for executing a game in which a virtual space is provided.

### BACKGROUND AND SUMMARY

It is known that games in which a virtual space is provided and a player proceeds by manipulating a player character in the virtual space. In such games, a virtual camera is set up in the virtual space and images taken virtually by a virtual camera are provided to the player as game images. Furthermore, games are known in which the player character can board a vehicle object in such a virtual space and move around the virtual space, and games are also known in which the virtual camera is controlled differently when the player character is boarding the vehicle object and when the player character is not boarding the vehicle object (for example, see https://www.pokemon.com/us/pokemon-video-games/pokemon-ultra-sun-and-pokemon-ultra-moon).

The present disclosure provides a novel control in games in which a virtual camera is controlled differently when a vehicle object is boarded and when it is not boarded.

### Configuration 1

A non-transitory computer-readable storage medium in an aspect has following instructions stored therein. The instructions, when executed by one or more processors of an information processing device, cause the one or more processors to:
in a first mode,
   control movement of a player character in a virtual space based on a first directional input;
   control a position of a virtual camera according to a position of the player character;
   control a facing direction of the player character in the virtual space based on the second directional input;
   control a facing direction of the virtual camera to be in line with the facing direction of the player character; and
   make the player character board a vehicle object based on a boarding instruction, and then switch to the second mode,
in the second mode,
   control a facing direction of the vehicle object in the virtual space in which the player character is boarded based on a third directional input;
   control the facing direction of the virtual camera in the virtual space based on a fourth directional input;
   control a position of the virtual camera based on the facing direction of the virtual camera; and
   make the player character disembark from the vehicle object based on a disembark instruction, and then switch to the first mode, wherein
   when making the player character disembark from the vehicle object, set the facing direction of the player character to be in line with the facing direction of the virtual camera.

This configuration enables a smooth transition of the game image provided by the virtual camera when the player character disembarks from the vehicle object, thereby improving the user experience.

### Configuration 2

In the non-transitory computer-readable storage medium of Configuration 1,
the first directional input and the third directional input may be inputs to the same input member.

This configuration allows the player character to be moved by the same input member in the first mode and the second mode, providing intuitive operation to the player and improving the user experience.

### Configuration 3

In the non-transitory computer-readable storage medium of Configuration 1,
the second directional input and the fourth directional input may be inputs to the same input member.

This configuration allows the direction of the virtual camera to be changed by the same input member in the first mode and the second mode, providing intuitive operation to the player and improving the user experience.

### Configuration 4

In the non-transitory computer-readable storage medium of Configuration 1,
the instructions, when they are executed on the one or more processors, may further cause the one or more processors to:
in the first mode,
   set a facing direction of the vehicle object in line with the direction of the first directional input when making the player character board the vehicle object based on the boarding instruction, in case that the first directional input is being made.

This configuration allows the direction of the vehicle object to be controlled so that it follows the direction of movement of the player character, which makes movement after boarding smoother and improves the user experience.

### Configuration 5

In the non-transitory computer-readable storage medium of Configuration 4,
the instructions, when executed on the one or more processors, may cause the one or more processors to:
in the first mode,
   control the facing direction of the vehicle object in line with the facing direction of the player character when making the player character board the vehicle object based on the boarding instruction, in a case that the first directional input is not being made.

With this configuration, the control of the facing direction of the vehicle object when boarding the vehicle object will differ depending on whether a directional input has been made, thereby improving user convenience and experience.

### Configuration 6

In the non-transitory computer-readable storage medium of Configuration 4,
the instructions, when executed on the one or more processors, may cause the one or more processors to:
in the first mode,
   bring the vehicle object closer to the player character in a direction based on the first directional input when making the player character board the vehicle object based on the boarding instruction; and
   make the player character board the vehicle object when the vehicle object approaches the player character to a predetermined positional relationship.

This configuration allows the player to easily understand the game specifications and improves the user experience because the user can see the vehicle object approaching with a speed based on the first directional input when boarding the vehicle object.

### Configuration 7

In the non-transitory computer-readable storage medium of Configuration 1,
the instructions, when executed on the one or more processors, may cause the one or more processors to:
in the second mode,
   make the player character disembark from the vehicle object after setting the facing direction of the player character in line with the facing direction of the virtual camera based on the disembark instruction.

This configuration improves the user experience because the switching of the game image by the virtual camera control at the time of disembarking can be made convincing and the user can easily understand the game specifications.

### Configuration 8

In the non-transitory computer-readable storage medium of Configuration 1,
the instructions, when executed on the one or more processors, may further cause the one or more processors to:
in the second mode,
   perform a scan of a scannable object based on a scan instruction when the scannable object is within a field of view of the virtual camera; and
   set the facing direction of the virtual camera so that the virtual camera faces the scannable object when the scan is performed.

This configuration improves the user experience because the scan of the scannable object can be performed even while the player character is boarding the vehicle object, and when the scan is being performed, it is easy to understand which object is being scanned for.

### Configuration 9

In the non-transitory computer-readable storage medium of Configuration 8,
the instructions, when executed on the one or more processors, may further cause the one or more processors to:
in the first mode,
   perform a predetermined action on the scannable object based on an action instruction, wherein
   the predetermined action is not executable in the second mode.

With this configuration, for example, if the player wants to perform a predetermined action on a scannable object after performing a scan of the scannable object while boarding a vehicle object, the player can perform the predetermined action after disembarking the vehicle object, and in doing so, since the virtual camera is already facing the scannable object when the scan is performed, there is no need to point the virtual camera at the scannable object again after the boarding is released, and the user experience is improved.

### Configuration 10

In the non-transitory computer-readable storage medium of Configuration 1,
the instructions, when executed by the one or more processors, may cause the one or more processors to:
in the first mode,
   cause the virtual camera to acquire a first person perspective image by controlling the position of the virtual camera to be the same as the position of the player character.

This configuration provides a first person perspective image when the player character is not boarding a vehicle object.

### Configuration 11

In the non-transitory computer-readable storage medium of Configuration 1,
the instructions, when executed on the one or more processors, may cause the one or more processors to:
in the second mode,
   cause the virtual camera to acquire a third person perspective image by controlling the position of the virtual camera to be different from the position of the player character.

This configuration provides a third person perspective image when the player character is boarding a vehicle object.

### Configuration 12

In the non-transitory computer-readable storage medium of Configuration 1,
the instructions, when executed on the one or more processors, may further cause the one or more processors to:
in the first mode,
   switch to a third mode based on a predetermined input,
in the third mode,
   control movement of the player character in the virtual space based on a fifth directional input, which is an input to the same input member as the first directional input;
   control the facing direction of the player character based on a movement control of the player character; and
   control the position and facing direction of the virtual camera based on the position of the player character.

This configuration provides a different control of the virtual camera and player character from the first and second modes, which improves the user experience.

### Configuration 13

An information processing system in an aspect is an information processing system for executing a game in which a virtual space is provided, comprising one or more processors and a memory coupled thereto, the one or more processors being configured to control the information processing system to perform at least:
controlling a player character in the virtual space;
controlling a virtual camera;
controlling a vehicle object in the virtual space;
in the first mode,
   controlling movement of the player character in the virtual space based on a first directional input, controlling a facing direction of the player character in the virtual space based on a second directional input, and making the player character board the vehicle object based on a boarding instruction;
   the virtual camera control unit controlling a position of the virtual camera based on a position of the player character and controlling a facing direction of the virtual camera to be in line with the facing direction of the player character; and
   the mode switching unit switching the first mode to the second mode after the player character is boarded on the vehicle object;
in the second mode,
   the vehicle control unit controlling the facing direction of the vehicle object in the virtual space in which the player character is boarded based on a third directional input;
   the virtual camera control unit controlling the facing direction of the virtual camera in the virtual space based on the fourth directional input;
   the player character control unit making the player character disembark from the vehicle object based on a disembark instruction; and
   the mode switching unit switching the second mode to the first mode after disembarking the player character from the vehicle object; and
   the player character control unit and/or the virtual camera control unit setting the facing direction of the player character to be in line with the facing direction of the virtual camera when making the player character disembark from the vehicle object.

This configuration also improves the user experience by providing a smooth transition of the game image provided by the virtual camera when the player character disembarks from the vehicle object.

### Configuration 14

In the information processing system of Configuration 13, the first directional input and the third directional input may be inputs to the same input member, and the second directional input and the fourth directional input may be inputs to the same input member.

### Configuration 15

The one or more processors may be configured to control the information processing system to further perform:
in the first mode,
   setting a facing direction of the vehicle object in line with the direction of the first directional input when making the player character board the vehicle object based on the boarding instruction, in case that the first directional input is being made.

### Configuration 16

The one or more processors may be configured to control the information processing system to further perform:
in the second mode,
   making the player character disembark from the vehicle object after setting the facing direction of the player character in line with the facing direction of the virtual camera based on the disembark instruction.

### Configuration 17

An information processing method in an aspect is an information processing method for executing a game in which a virtual space is provided, the information processing method executed using one or more processors, the method comprising:
in a first mode,
   controlling movement of a player character in the virtual space based on a first directional input;
   controlling a position of a virtual camera according to a position of the player character;
   controlling a facing direction of the player character in the virtual space based on the second directional input;
   controlling a facing direction of the virtual camera to be in line with the facing direction of the player character; and
   making the player character board a vehicle object based on a boarding instruction, and then switching to the second mode,
in the second mode,
   controlling a facing direction of the vehicle object in the virtual space in which the player character is boarded based on a third directional input;
   controlling the facing direction of the virtual camera in the virtual space based on a fourth directional input;
   controlling a position of the virtual camera based on the facing direction of the virtual camera; and
   making the player character disembark from the vehicle object based on a disembark instruction, and then switching to the first mode, wherein
   when making the player character disembark from the vehicle object, set the facing direction of the player character to be in line with the facing direction of the virtual camera.

### Configuration 18

In the information processing method of Configuration 17, the first directional input and the third directional input may be inputs to the same input member, and the second directional input and the fourth directional input may be inputs to the same input member.

### Configuration 19

In the information processing method of Configuration 17,
the information processing method may further comprise:
in the first mode,
   setting a facing direction of the vehicle object in line with the direction of the first directional input when making the player character board the vehicle object based on the boarding instruction, in case that the first directional input is being made.

### Configuration 20

In the information processing method of Configuration 17,
the information processing method may further comprise:
in the second mode,
   making the player character disembark from the vehicle object after setting the facing direction of the player character in line with the facing direction of the virtual camera based on the disembark instruction.

### BRIEF DESCRIPTION OF DRAWINGS

FIG. 1 shows the appearance of the information processing system;

FIG. 2 is a block diagram showing the configuration of the information processing device of the embodiment;

FIG. 3A illustrates the control of the player character in the first mode of the embodiment;

FIG. 3B illustrates the control of the player character in the first mode of the embodiment;

FIG. 3C illustrates the control of the player character in the first mode of the embodiment;

FIG. 4A is a transition diagram illustrating the transition from the first mode to the second mode of the embodiment;

FIG. 4B is a transition diagram illustrating the transition from the first mode to the second mode of the embodiment;

FIG. 4C is a transition diagram illustrating the transition from the first mode to the second mode of the embodiment;

FIG. 5A illustrates the control of player characters and vehicle objects in the second mode of the embodiment;

FIG. 5B illustrates the control of player characters and vehicle objects in the second mode of the embodiment;

FIG. 5C illustrates the control of player characters and vehicle objects in the second mode of the embodiment;

FIG. 6A is a transition diagram illustrating the transition from the second mode to the first mode of the embodiment;

FIG. 6B is a transition diagram illustrating the transition from the second mode to the first mode of the embodiment;

FIG. 6B is a transition diagram illustrating a variation of the transition from the second mode to the first mode of the embodiment;

FIG. 7A is a transition diagram illustrating the scanning of a scannable object in the second mode of the embodiment; and

FIG. 7B is a transition diagram illustrating the scanning of a scannable object in the second mode of the embodiment.

### EMBODIMENTS OF THE DISCLOSURE

The information processing system and information processing program of the embodiment are described below with reference to the drawings. The following description is only an example of a preferred embodiment and is not intended to limit the invention described in the claims.

In the following embodiment, a game is provided in which a virtual camera is set up in a virtual space, and a player object in the virtual space is controlled to advance the game while the image taken virtually by the virtual camera is provided as a game image. In the following embodiment, a game in which the player object can board a vehicle object and move according to the situation is provided.

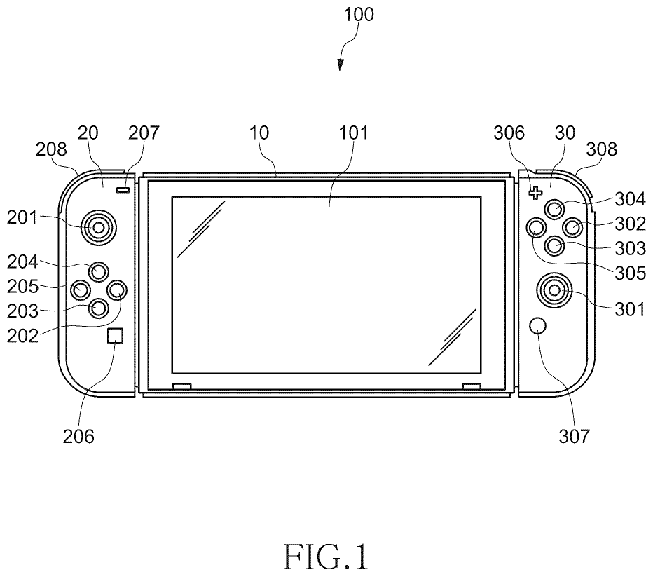

FIG. 1 shows the appearance of the information processing device of the embodiment. In this embodiment, the information processing device is configured as a gaming device 100 that executes a game as information processing. In this embodiment, the information processing device is a gaming device as a dedicated device for playing games, but instead of this, a general-purpose computer executing a game program, such as a smartphone, tablet computer, laptop computer, or desktop computer may be configured as a gaming device.

The gaming device 100 in this embodiment includes a main body 10 equipped with a touch panel display 101, a left controller 20, and a right controller 30. The left controller 20 and the right controller 30 can be attached to and detached from the main body 10 of the gaming device. In other words, the gaming device 100 can be used as an integrated device with the left controller 20 and right controller 30 attached to the main body 10. The gaming device 100 can also be used as a separate device with the main body 10 of the gaming device and the left controller 20 and the right controller 30.

The left controller 20 is equipped with an analog stick 201 for inputting directions and four operation buttons (specifically, a right direction button 202, a down direction button 203, an upward direction button 204, and a left direction button 205) as operation members to be operated by the user. In addition, the left controller 20 is equipped with a recording button 206, a −(minus) button 207, and an L button 208 as the operation members to be operated by the user.

Like the left controller 20, the right controller 30 is equipped with an analog stick 301 for inputting directions and four operation buttons (specifically, an A button 302, a B button 303, an X button 304, and a Y button 305) as operation members. In addition, the right controller 30 is also equipped with a +(plus) button 306, a home button 307, and an R button 308 as the operation members.

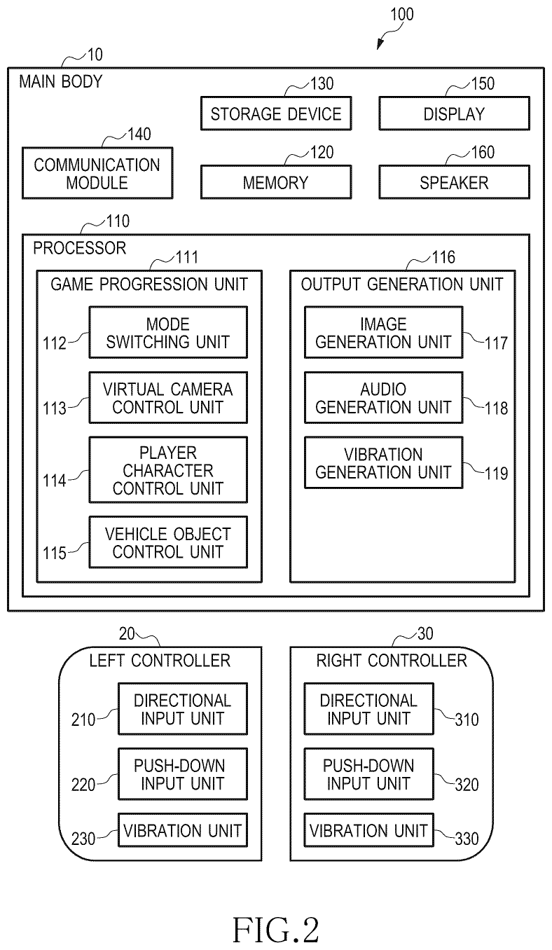

FIG. 2 is a block diagram showing the configuration of the information processing device of the embodiment. As described above, the information processing device in this embodiment is configured as a gaming device 100. As described with reference to FIG. 1, the gaming device 100 is equipped with the main body 10, the left controller 20, and the right controller 30.

The main body 10 has a computer system comprising a processor 110, a memory 120, and a storage device 130. The processor 110, as an arithmetic processor, expands the game program as an information processing program stored in the memory device 130 into the memory 120 and executes the game program. The main body 10 of the gaming device may be equipped with one processor 110 that performs all necessary calculations and controls, or it may be equipped with multiple processors 110, including a processor that performs general calculations and controls and a processor that performs graphics processing and the like.

The storage device 130 may be built into the main body 10 or may be a portable storage device that is removable from the main body 10 as a non-transitory computer-readable storage medium. In the case where the storage device 130 is built into the main body 10, the game program may be downloaded to the main body 10 via a communication network and stored in the storage device 130. The portable device may be a cartridge, and the main body 10 may have a structure to mount the cartridge.

The main body 10 has a display 150 and a speaker 160 as a configuration for outputting the results of information processing by the processor 110. The display 150 may be configured as a touch panel display equipped with a touch sensor.

The display 150 displays images generated by the image generation unit 117 described below as a result of information processing by the processor 110. The main body 10 of the gaming device as an information processing device in this embodiment displays game images on the display 150. Speaker 160 outputs audio generated by audio generation unit 118 described below as a result of information processing by processor 110.

The left controller 20 has a directional input unit 210, a push-down input unit 220, and a vibration unit 230. The directional input unit 210 corresponds to the analog stick 201 of FIG. 1. The push-down input unit 220 corresponds to the buttons 202 to 208 as various operation members in FIG. 1. The directional input unit 210 and the push-down input unit 220 transmit the input operations as operation signals to the main body 10 of the gaming device. The vibration unit 230 is a vibrator that vibrates in response to vibration instructions generated by the vibration generator 119 described below. The vibration by the vibration unit 230 can be felt by the player grasping the left controller 20.

The right controller 30 has a directional input unit 310, a push-down input unit 320, and a vibration unit 330. The directional input unit 310 corresponds to the analog stick 301 of FIG. 1. The push-down input unit 320 corresponds to the buttons 302 to 308 as various operation members in FIG. 1. The directional input unit 310 and the push-down input unit 320 transmit the input operations as operation signals to the main body 10 of the gaming device. The vibration unit 330 is a vibrator that vibrates in response to vibration instructions generated by the vibration generator 119 described below. The vibration by the vibration unit 330 can be felt by the player grasping the right controller 30.

The directional input unit 210, the push-down input unit 220, the directional input unit 310, and the push-down input unit 320 input operations to the processor 110 by outputting operation signals, and can be collectively referred to as input devices. The display 150, the speaker 160, the vibration unit 230, and the vibration unit 330 all output the results of information processing by the processor 110 as visual information, audio information, and feel information, respectively, and can be collectively called output devices.

The input device may be, for example, a mouse used for a general-purpose computer, a touch sensor provided on the display 150, or an acceleration sensor provided on the main body 10, the left controller 20, or the right controller 30. A voice recognition system that recognizes speech by inputting the user's voice, or an image recognition system that recognizes images by capturing the user's gestures may also be used as an input device.

In this embodiment, the main body 10 of the gaming device, the left controller 20, and the right controller 30 are separate, but they may be integrated in an inseparable manner.

The following provides a description of the games played in this embodiment. The game described below is only one example, and the present disclosure is applicable to games with other specifications. The processor 110 has a game progression unit 111 and an output generation unit 116 that generates output signals reflecting the results of processing by the game progression unit 111 in order to execute the game.

The game progression unit 111 has a mode switching unit 112, a virtual camera control unit 113, a player character control unit 114, and a vehicle object control unit 115. The output generation unit 116 has a image generation unit 117, an audio generation unit 118, and a vibration generation unit 119. As described above, these units of the processor 110 are realized by the instructions contained in the game program when the processor 110 executes the game program, and can be referred to as functions provided by the processor 110 executing the game program, or as functions or modules of the game program.

In this embodiment, the game progression unit 111 provides a game in which a player operates a player character in a virtual space to accomplish a mission. Objects such as the ground, structures, articles, and enemy characters are set in the virtual space. A virtual camera is set up in the virtual space. Images taken virtually by the virtual camera are generated and displayed according to the viewpoint position and capturing direction of the virtual camera. In this embodiment, this displayed image is called the game image.

The player character can move within the virtual space and can also change its direction within the virtual space. In this embodiment, the player character can shoot at objects in the virtual space with the weapon he/she is carrying and can also scan objects in the virtual space.

In addition, by satisfying predetermined conditions, the player character can board and disembark from a vehicle object. The vehicle object may be placed in the virtual space before boarding, or it may appear in the virtual space based on boarding input, for example. The player character disembarking from the vehicle object is also referred to as de-boarding. The player character can perform actions such as moving, shooting, and scanning in either a state of being boarded on the vehicle object or a state of not being boarded on the vehicle object. In another embodiment, the actions that can be performed by the player character may differ between the boarded state and the non-boarded state.

The mode switching unit 112 switches the control mode between a first mode in which the player character is not boarding the vehicle object and a second mode in which the player character is boarding the vehicle object. The mode switching unit 112 switches the control mode to the second mode when the player character boards the vehicle object in the first mode, and switches the control mode to the first mode when the player character disembarks from the vehicle object in the second mode.

As described above, the control mode is switched as the player character boards and disembarks from the vehicle object. However, as described below, boarding and disembarking of a player character with respect to a vehicle object may be performed based on an operation input from the player, i.e., an instruction from the player, or it may be performed based on a game instruction according to the progress of the game without a player's instruction. Therefore, the mode switching unit 112 may switch the control mode indirectly in response to the player's instructions, or it may switch the control mode based on the progress of the game without being based on the player's instructions.

The image generation unit 117, audio generation unit 118, and vibration generation unit 119 generate and output game video, game audio, and vibration instructions, respectively, based on the processing of the game progression unit 111. The game video generated by the image generation unit 117 is displayed on display 150. The game audio generated by audio generation unit 118 is output from speaker 160. The vibration instructions generated by the vibration generation unit 119 are transmitted to the left controller 20 and/or the right controller 30 via the communication module 140. The vibration unit 230 of the left controller 20 and the vibration unit 330 of the right controller 30 receive the vibration instructions and vibrate.

In the first mode, the virtual camera control unit 113 controls the position and facing direction of the virtual camera VC so that the position and facing direction of the virtual camera VC match those of the player character. As a result, the image generation unit 117 generates game images from the first-person perspective of the player character (i.e., the subjective viewpoint). This provides a first person perspective (FPP) game, in which the player character is basically not displayed on the game screen, but parts of the player character's arms and hands or a weapon held in the player character's hands may be displayed on the game screen.

In the second mode, the virtual camera control unit 113 controls the position and facing direction of the virtual camera VC so that the virtual camera VC captures the player character PC from a different position than the player character PC. As a result, the image generation unit 117 generates game images from the third person perspective (i.e., objective perspective) of the player character. This provides a third person perspective (TPP) game.

In a TPP game, the player character and the virtual camera can basically be controlled independently. In this embodiment, the virtual camera control unit 113 receives instructions to change the facing direction of the virtual camera VC. In order to be able to capture the player character, the virtual camera VC moves around the player character in response to the instruction to change the facing direction of the virtual camera.

In the first mode, when switching to the second mode, the virtual camera is controlled by the virtual camera control unit 113 to switch the game image from the first person perspective (FPP) to the third person perspective (TPP). In the second mode, when switching to the first mode, the virtual camera is controlled by the virtual camera control unit 113 to switch the game image from the third person perspective (TPP) to the first person perspective (FPP). The following describes FPP in the first mode, switching from FPP to TPP in the first mode, TPP in the second mode, various processes in the second mode, and switching from TPP to FPP in the second mode in this order.

### (FPP in the First Mode)

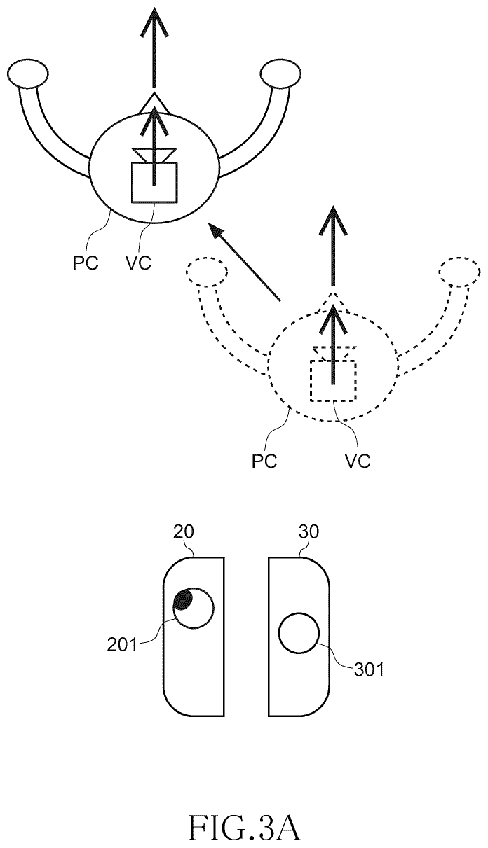

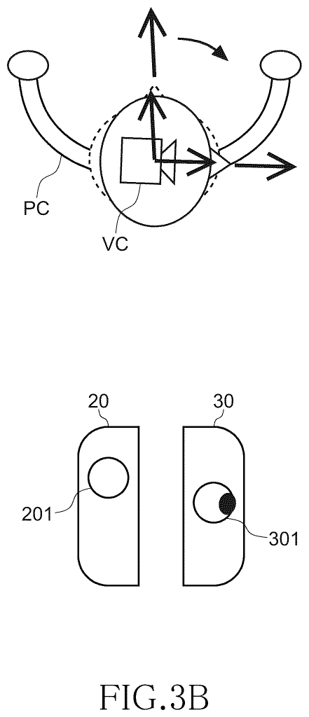

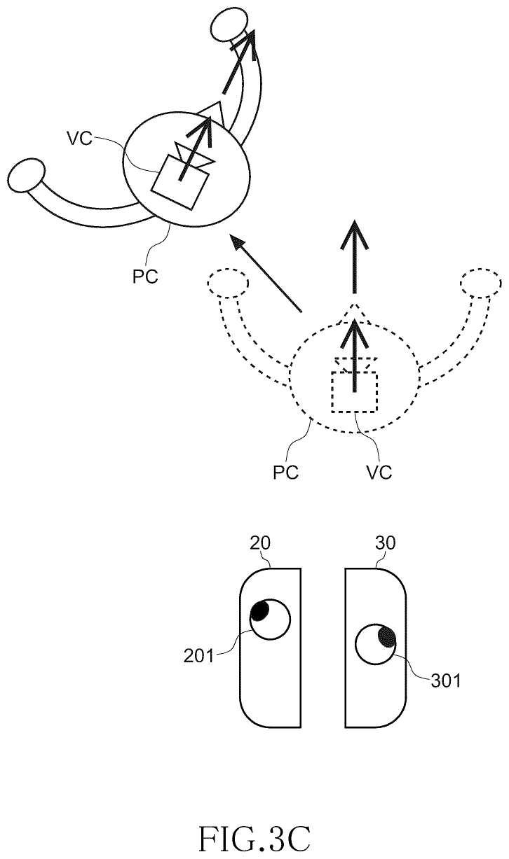

FIGS. 3A to 3C illustrate player character control in the first mode. In the first mode, as shown in FIG. 3A, the player character control unit 141 controls the movement of the player character PC in the virtual space based on the directional input to the analog stick 201 of the left controller 20. In the example in FIG. 3A, an upper left directional input is made to the analog stick 201, and as a result, the player character control unit 141 moves the player character PC to the upper left (front left from the player character's perspective) within the virtual space. All of the control inputs assigned to each operation or the operation members assigned to the directional input are examples and are not limited to these.

As shown in FIG. 3B, the player character control unit 141 sets the facing direction of the player character in the virtual space based on the directional input to the analog stick 301 of the right controller 30. In the example in FIG. 3B, a right directional input is made to the analog stick 301, and as a result, the player character control unit 141 makes the player character PC face right in the virtual space.

The virtual camera control unit 113 controls the position of the virtual camera according to the position of the player character PC, and also controls the facing direction of the virtual camera to follow the facing direction of the player character PC. FIGS. 3A and 3B show an example. As shown in FIGS. 3A and 3B, in the first mode, the virtual camera control unit 113 controls the position and facing direction of the virtual camera VC so that it is in the same position and facing direction as the player character PC. In other words, in the first mode, the image generation unit 117 generates the first person perspective image of the player character PC by the virtual camera VC as a game image.

In the example of FIG. 3A, since the player character PC is moving to the upper left, the virtual camera control unit 113 moves the virtual camera VC also to the upper left so that the position of the virtual camera VC overlaps with the player character PC. In the example in FIG. 3B, the player character PC is facing upper right, so the virtual camera control unit 113 sets the direction of the virtual camera VC to upper right so that the direction of the virtual camera VC is the same direction as that of the player character PC.

Thus, in the first mode, the virtual camera VC moves as the player character PC moves, and the direction of the virtual camera VC changes as the player character PC changes direction. The movement of the player character PC is done according to the directional input to the analog stick 201 of the left controller 20, and the direction of the player character PC is changed according to the directional input to the analog stick 30 of the right controller 30. Therefore, it can be said that the virtual camera VC moves according to the directional input to the analog stick 201 of the left controller 20 and changes direction according to the directional input to the analog stick 301 of the right controller 30.

In the example of FIG. 3C, a directional input to the upper left is made to the analog stick 201 of the left controller 20, and a directional input to the upper right is made to the analog stick 301 of the right controller 30. In this case, the player character PC moves to the upper left in the virtual space while facing the upper right. At this time, according to the movement and direction of the player character PC, the virtual camera VC also faces upper right and moves to upper left.

As described above, in the first mode, the analog stick 201 of the left controller 20 is used to direct the direction of movement of the player character PC, and the analog stick 301 of the right controller 30 is used to direct the front direction of the player character PC and the capturing direction of the virtual camera VC (these directions are coincident). In other words, the instruction of movement of the player character PC and the instruction of the player character PC and the virtual camera VC can be made independently of each other, and they are also controlled independently by the player character control unit 114 and the virtual camera control unit 113, respectively.

The player character control unit 141 and the virtual camera control unit 131 may change the facing direction of the player character PC and the virtual camera VC in the vertical direction according to the vertical directional input to the analog stick 301 of the right controller 30.

(Switching from FPP to TPP in the First Mode)

In the first mode in which the player character PC moves in the virtual space by itself without boarding a vehicle object, the player character control unit 141 makes the player character PC board the vehicle object based on a boarding instruction by pressing the X button 304 of the right controller 30. The boarding instruction may be automatically given when the game state satisfies a predetermined condition, without being based on an instruction to the controller by the player.

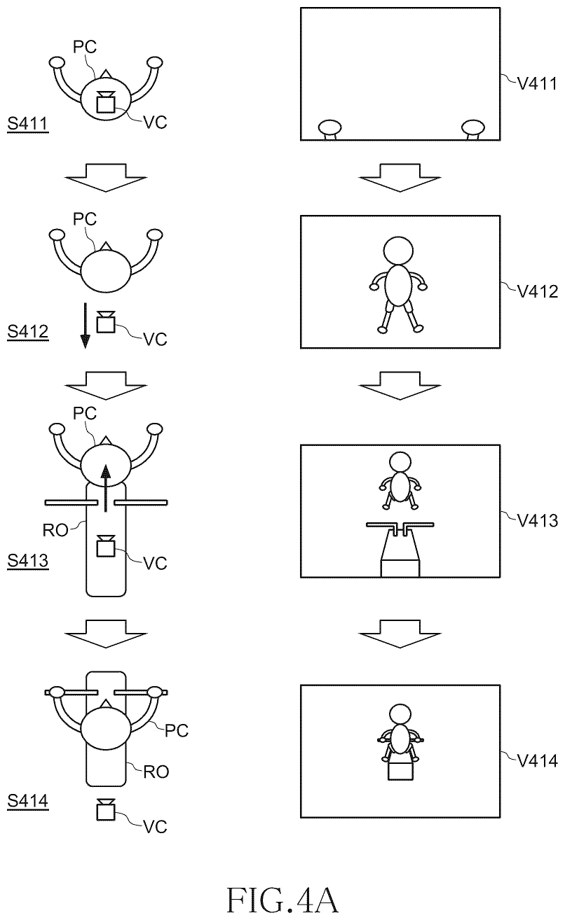

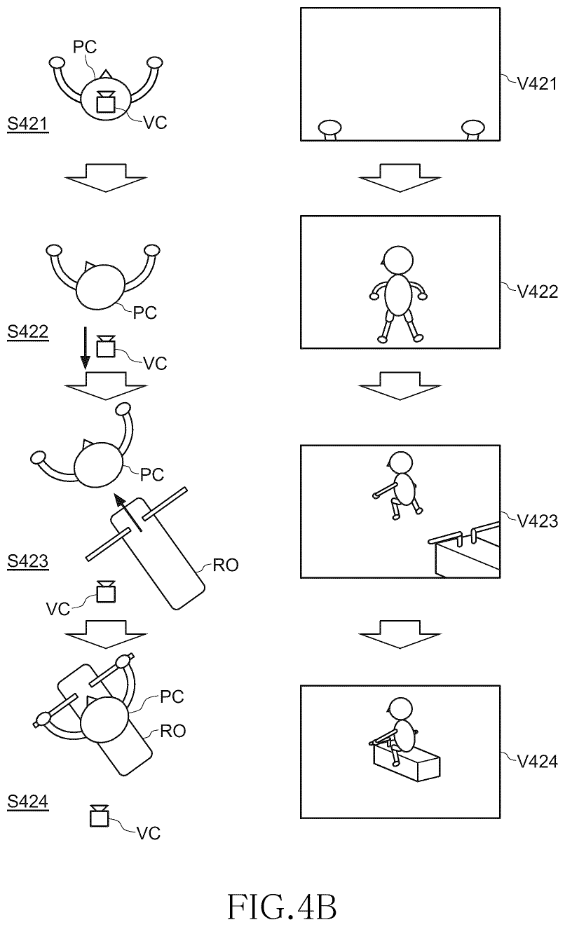

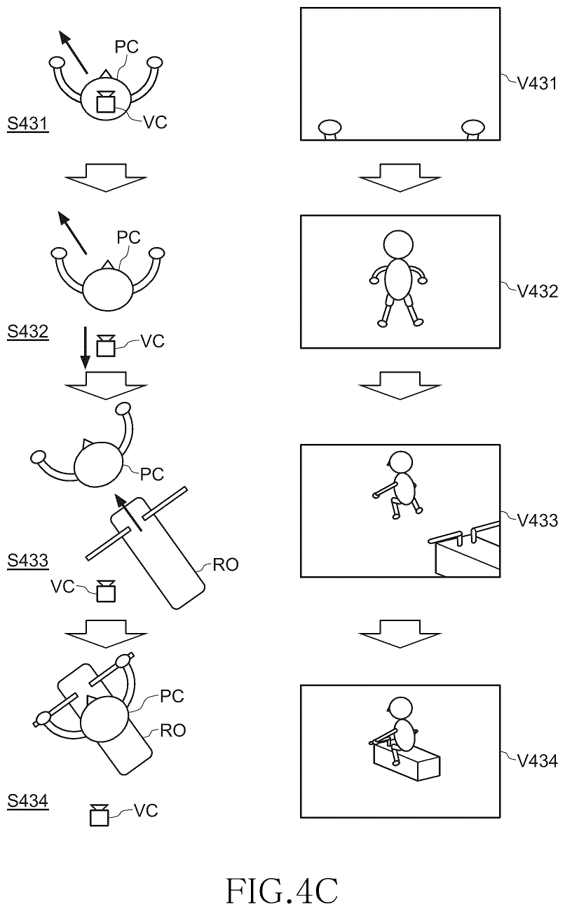

FIGS. 4A to 4C are transition diagrams illustrating the transition from the first mode to the second mode. In FIGS. 4A to 4C, the left side shows the transition of the game state and the right side shows the transition of the game image. FIG. 4A is a transition diagram showing an example of player character PC boarding a vehicle object from a stationary state. In state S411, player character PC is stationary. The virtual camera VC is positioned overlapping with the player character PC.

At this time, the image generation unit 117 generates the first person perspective image of the player character PC as the game image V411. In this state, when the player presses the X button 304 to indicate boarding the vehicle object RO, the player character control unit 114 causes the player character PC to start the action of boarding the vehicle object RO. In state S412, in response to the boarding instruction, the virtual camera control unit 113 moves the virtual camera VC away from the player character PC and toward the rear of the player character PC. As a result, the image generation unit 117 generates a third person perspective game image 412 in which the whole body of the player character PC is shown.

In state S413, the virtual camera control unit 113 continues to move the virtual camera VC away from the player character PC, while the vehicle object control unit 115 moves the vehicle object RO from behind the player character PC to approach the player character PC. When the vehicle object RO approaches the player character PC, the player character control unit 114 makes the player character PC jump on the spot to board the vehicle object RO, as shown in game image V413.

In state S414, the vehicle object RO continues to approach the player character PC, and the player character PC gets under the jumping player character PC, and the player character PC boards the vehicle object RO. In game image V414, boarding of the player character PC onto the vehicle object RO is completed. At this time, the virtual camera VC is set behind the player character PC boarding the vehicle object RO at a predetermined distance.

As shown in FIG. 4A, the vehicle object RO is a motorcycle-like vehicle, and the player object straddles and boards the vehicle object RO. The mode of the vehicle object RO is not limited to this, and it may be a vehicle object where the player character PC boards in the vehicle, such as a car-like one. The vehicle object is not limited to one that travels on the ground, but may also travel at least one of the following: in the air, on the water, in the water, or under the ground.

FIGS. 4B and 4C illustrate the transition of the game state and game image when a directional input is made when the player object PC boards the vehicle object RO. In the example of FIG. 4B, after the X button 304 of the right controller 30 is pressed, a directional input in the upper left direction is made with the analog stick 301 of the right controller 30, which causes the boarding action to take place with the player character PC facing upper left (front left from the player character's perspective).

In state S421, the player character PC is facing front, and the image generation unit 117 generates the first person perspective game image V421 as the game image. In this state, when boarding is indicated by pressing the X button 304 and the upper left direction is input to the analog stick 301 of the right controller 30, as shown in state S422, the player character control unit 114 rotates the player character PC to face upper left and the virtual camera control unit 113 moves the virtual camera VC behind the player character so that it is facing away from the player character PC. By moving the virtual camera VC away from the player character PC, the image generation unit 117 generates a third person perspective game image V422 that shows the whole body of the player character PC facing left front.

In state S423, a vehicle object RO appears in the virtual space, but because the player character PC is facing upper left, the vehicle object RO moves to approach the player character PC from the lower right, which is behind the player character PC. The image generation unit 117 accordingly generates the game image V423 in which the vehicle object RO approaches from the bottom right of the frame. As in the example in FIG. 4a, the player character control unit 114 makes the player character PC jump, and the vehicle object control unit 115 makes the vehicle object RO dive under the jumping player character PC.

In state S424, the player character control unit 114 makes the player character PC board the vehicle object RO. At this time, the player character PC and the vehicle object RO are aligned in the same direction. The image generation unit 117 generates the game image V424 of the player character PC boarding the vehicle object RO facing the upper left direction.

In the example of FIG. 4C, after the X button 304 of the right controller 30 is pressed, a directional input in the upper left direction is made with the analog stick 201 of the left controller 20, which causes the boarding action with the player character PC moving to the upper left (front left from the player character's perspective).

In state S431, the player character PC is facing forward, and the image generation unit 117 generates the first person perspective game image V431 as the game image. In this state, when boarding is indicated by pressing the X button 304 and a directional input of upper left is made to the analog stick 201 of the left controller 20, as shown in state S432, the player character control unit 114 moves the player character PC to upper left, and the virtual camera control unit 113 moves the virtual camera VC behind the player character so that it is away from the player character PC. By moving the virtual camera VC away from the player character PC, the image generation unit 117 generates a third person perspective game image V432 that shows the whole body of the player character PC facing left front.

In state S433, a vehicle object RO appears in the virtual space. Since the player character PC is moving to the upper left, the vehicle object RO moves to approach the player character PC from the lower right, which is behind the player character PC. Accordingly, the image generation unit 117 generates the game image V423 in which the vehicle object RO approaches from the lower right of the frame.

The player character control unit 114 makes the player character PC jump. At this time, the player character control unit 114 rotates the direction of the player character PC so that the player character PC and the approaching vehicle object RO are facing the same direction. The vehicle object control unit 115 causes the vehicle object RO to drive under the rotating player character PC while jumping.

In state S434, the player character control unit 114 makes the player character PC board the vehicle object RO. At this time, the player character PC and the vehicle object RO are aligned in the same direction. The image generation unit 117 generates the game image V434 of the player character PC boarding the vehicle object RO facing the upper left direction.

As in the example of FIG. 4C, when a directional input is made to the analog stick 201 of the left controller 20 to move the player character PC in the case where the player character PC is boarding the vehicle object RO, the vehicle object control unit 115 increases the approach speed of the vehicle object RO, which is placed in the virtual space and moves closer to the player character PC, according to the directional input to the analog stick 201, compared to the case where no directional input is made. In this case, the vehicle object control unit 115 sets the magnitude of the speed increase of the vehicle object according to the amount of tilt of the analog stick 201. The magnitude of the speed increase may vary in magnitude continuously according to the tilt amount, or may be set to take a certain value when the tilt amount exceeds a certain threshold value.

Furthermore, the vehicle object control unit 115 may set the approach speed of the vehicle object RO to a maximum when the R button 308 of the right controller 30 is pressed when the vehicle object RO approaches the player character PC. The maximum speed at this time may be even greater than the approaching speed of the vehicle object RO when the analog stick 201 is tilted to the maximum without pressing the R button 308.

In the case of the examples in FIGS. 4B and 4C, i.e., when a directional input for changing the direction or moving the player character PC is made after the boarding instruction, the vehicle object control unit 115 controls the vehicle object RO to approach the player character PC from the opposite side of the directional input for the player character PC. Instead, the vehicle object control unit 115 causes the vehicle object RO to approach the player character PC from behind the virtual camera VC when the boarding instruction is given (so that the image generation unit 117 can generate the image from the bottom center of the game image frame). The direction of the vehicle object RO may be gradually rotated so that the direction of the vehicle object RO follows the direction of the player character PC before the player character PC boards the vehicle object RO.

In the case of the example in FIGS. 4B and 4C, i.e., when a directional input for changing the facing direction or moving the player character PC is made after the boarding instruction, the virtual camera control unit 113 controls the virtual camera VC to move backward (downward in FIGS. 4B and 4C) based on the direction of the player character PC at the time the boarding instruction was given.

Instead, in the case of FIG. 4B, the virtual camera control unit 113 may control the facing direction and position of the virtual camera VC so that the virtual camera VC moves around behind the player character PC according to the facing direction of the player character PC that is changed in response to the change in the facing direction of the player character PC after the boarding instruction, thereby the virtual camera VC turns behind the player character PC drawing a curved trajectory behind the player character PC.

In the case of FIG. 4C, as the player character control unit 114 rotates the facing direction of the player character PC to board the vehicle object RO approaching from the lower right, the virtual camera control unit 113 may control the direction and position of the virtual camera VC so that the virtual camera 113 follows a curved trajectory to go behind the player character PC while moving away from the player character PC.

By these controlling of the virtual camera, the image generation unit 117 will generate game images capturing the player character PC from behind.

In the above example, when the boarding instruction is received in the first mode, the boarding action shown in FIGS. 4A to 4C is followed to shift to the second mode in which the player character PC boards the vehicle object RO. However, for example, the order of the above boarding actions may be changed. Furthermore, when a boarding instruction is given, the player may switch from the first mode (first person perspective) to the second mode (third person perspective) without going through the boarding actions. At least part of the boarding action may be omitted as a process or may not be rendered.

The mode switching unit 112 switches the control mode to the second mode when the boarding of the player character PC onto the vehicle object RO is completed as described above in the first mode.

### (TPP in the Second Mode)

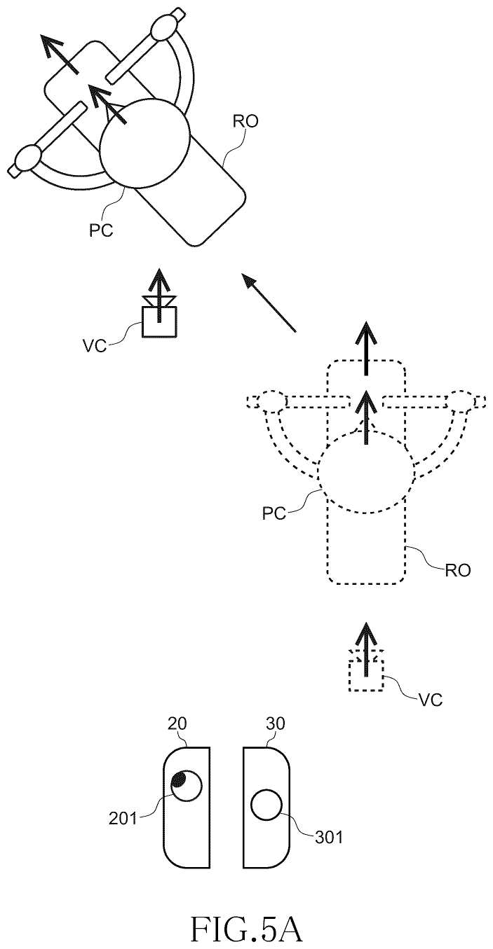

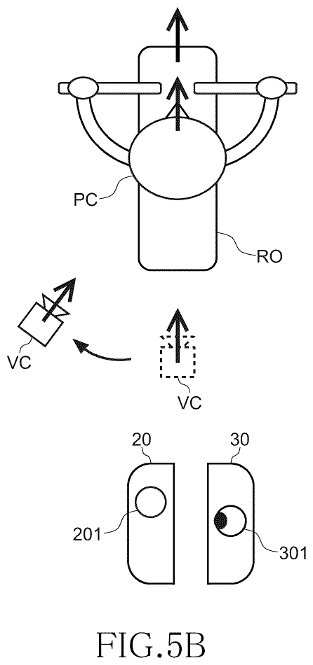

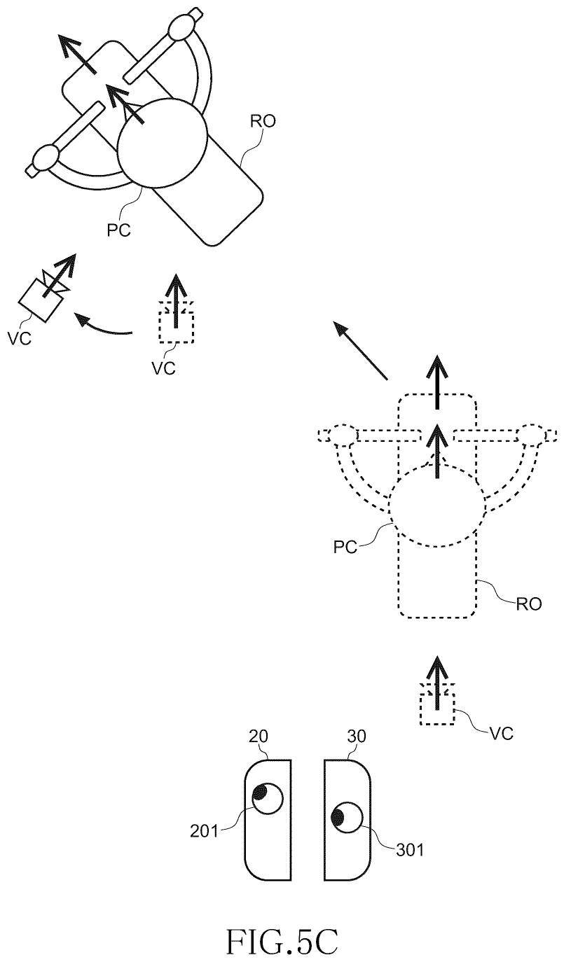

FIGS. 5A to 5c illustrate the control of the player character and the vehicle object in the second mode. In the second mode, as shown in FIG. 5A, the player character control unit 141 and the vehicle object control unit 115 control the facing direction and movement of the player character PC and the vehicle object RO in the virtual space based on the directional input to the analog stick 201 of the left controller 20.

In this case, the vehicle object control unit 115 sets the magnitude of the movement speed of the vehicle object according to the tilt amount of the analog stick 201. The magnitude of the movement speed may vary continuously according to the tilt amount, or it may be set to take a certain value when the tilt amount exceeds a certain threshold value. The movement speed or acceleration of the vehicle object RO may be set to a maximum when the R button 308 on the right controller 30 is pressed. The maximum speed in this case may be greater than the maximum speed at which the vehicle object RO approaches the player character PC when the player character PC boards the vehicle object RO.

In the example in FIG. 5A, a directional input in the upper left direction is being made to the analog stick 201, and as a result, the player character control unit 141 and the vehicle object control unit 151 makes the player character PC and the vehicle object RO face upper left and moves the player character PC and the object RO to the upper left (front left from the player character's perspective) in the virtual space.

As shown in FIG. 5B, the virtual camera control unit 131 sets the direction and position of the virtual camera VC in the virtual space based on the directional input to the analog stick 301 of the right controller 30. In the example shown in FIG. 5B, a left directional input is applied to the analog stick 301. As a result, the virtual camera control unit 131 causes the virtual camera VC to orbit leftward around the player character PC, keeping the player character at the center, while causing the virtual camera VC to rotate rightward, so that the virtual camera VC always faces the player character PC.

In the example in FIG. 5C, an upper left directional input is being made on the analog stick 201 of the left controller 20, and at the same time, a left directional input is being made on the analog stick 301 of the right controller 30. In this case, the player character control unit 141 and the vehicle object control unit 151 control the player character PC and the vehicle object RO in the same way as shown in FIG. 5A, and the virtual camera control unit 131 controls the virtual camera VC in the same way as shown in FIG. 5B.

In other words, the player character control unit 141 and the vehicle object control unit 151 move the player character PC and the vehicle object RO to the upper left (front left from the player character's perspective) in the virtual space, with the direction of the player character PC and the vehicle object RO facing the upper left, and at the same time, the virtual camera control unit 131 rotates the direction of the virtual camera VC to the right while turning the virtual camera VC to the left, with the player character PC as the center, so that the virtual camera VC faces the player character PC.

As described above, in the second mode where the player character PC is boarding the vehicle object RO, the facing direction and movement direction of the player character PC and the vehicle object RO are indicated according to the directional input to the analog stick 201 of the left controller 20. The position and facing direction of the virtual camera VC, which provides a third person perspective game image, is set according to the directional input to the analog stick 301.

In this system, the facing direction and movement direction of the player character PC and the vehicle object RO are indicated according to the directional input to the analog stick 201 of the left controller 20, but the vehicle object RO may move forward in the direction in which the vehicle object RO is facing by, for example, pressing the A button 302 of the right controller 30 while the facing direction of the player character PC and the vehicle object RO are indicated according to the directional input to the analog stick 201 of the left controller 20.

In this embodiment, as the virtual camera VC moves according to the directional input to the analog stick 301 of the right controller 30, the direction is changed so that the virtual camera VC always captures the player character PC. However, the virtual camera VC moves according to the directional input to the analog stick 301 of the right controller 30 and the direction of the virtual camera VC may be set by pressing the buttons 202 to 205 on the left controller 20. In other words, the change in the movement and the facing direction of the virtual camera VC may be directed by independent inputs.

In this embodiment, the directional input for moving the player character PC in the virtual space in the first mode (first directional input) and the directional input for changing the facing direction and moving the vehicle object RO in which the player character PC boards in the virtual space in the second mode (third directional input) are both performed with the analog stick 201 of the left controller 20. This allows intuitive operation by the player since the movement of the player character PC is performed by the same operation in the first mode and the second mode, but the first directional input and the third directional input may be made by different input members.

In the above embodiment, the directional input for changing the facing direction of the player character PC in the virtual space in the first mode (second directional input) and the directional input for changing the facing direction of the virtual camera in the virtual space in the second mode (fourth directional input) are both performed with the analog stick 301 of the right controller 30. This provides intuitive operation for the player, since the same operation is used to change the facing direction of the virtual camera VC in the first mode and the second mode, but the second directional input and the fourth directional input may be made by different input members.

(Switching from TPP to FPP in the Second Mode)

In the second mode in which the player character PC boards the vehicle object RO and moves in the virtual space, the player character control unit 114 removes the player character PC from the vehicle object RO based on a disembark instruction by pressing the X button 304 of the right controller 30. The disembark instruction may be automatically given when the game state satisfies a predetermined condition, without being based on an instruction to the controller by the player. For example, when the player character PC boarding the vehicle object RO is attacked by an enemy, the player character PC may be forcibly disembarked from the vehicle object RO.

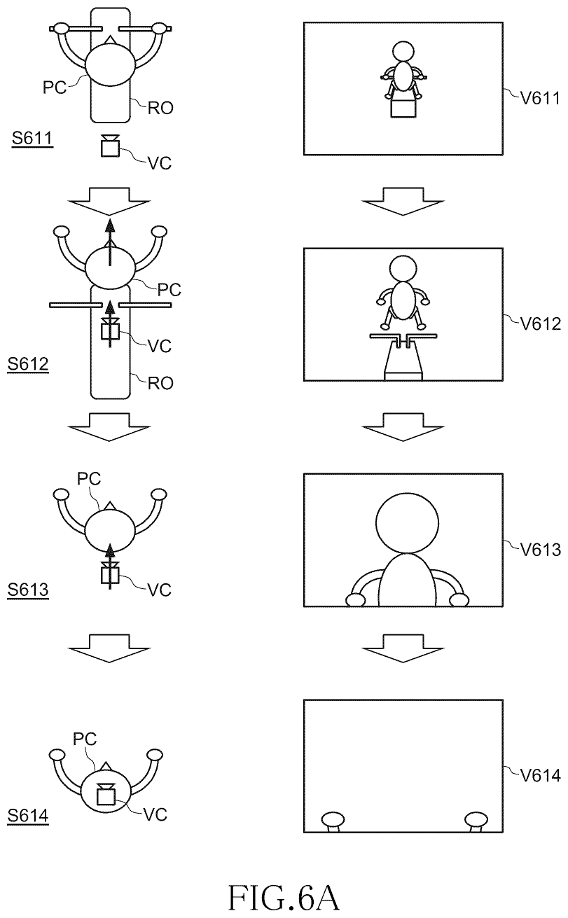

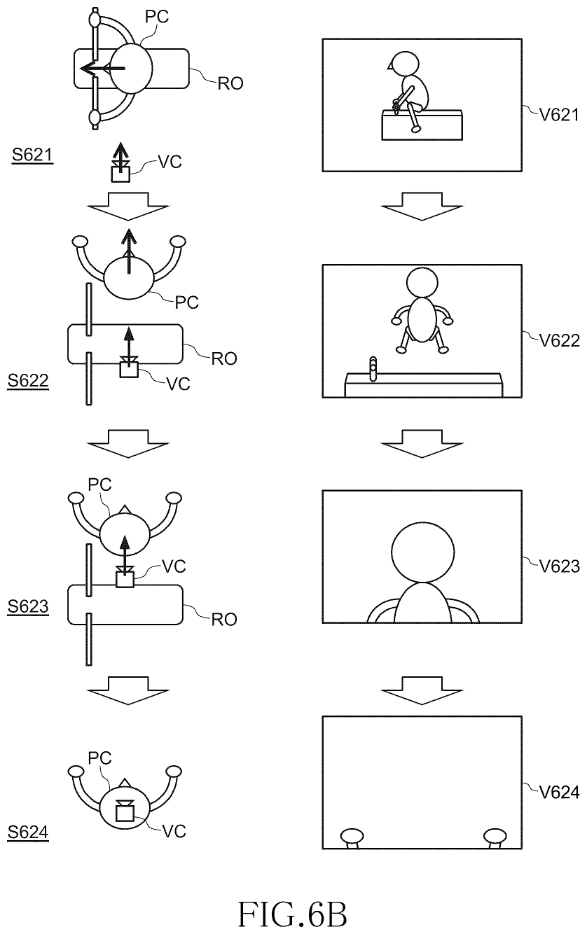

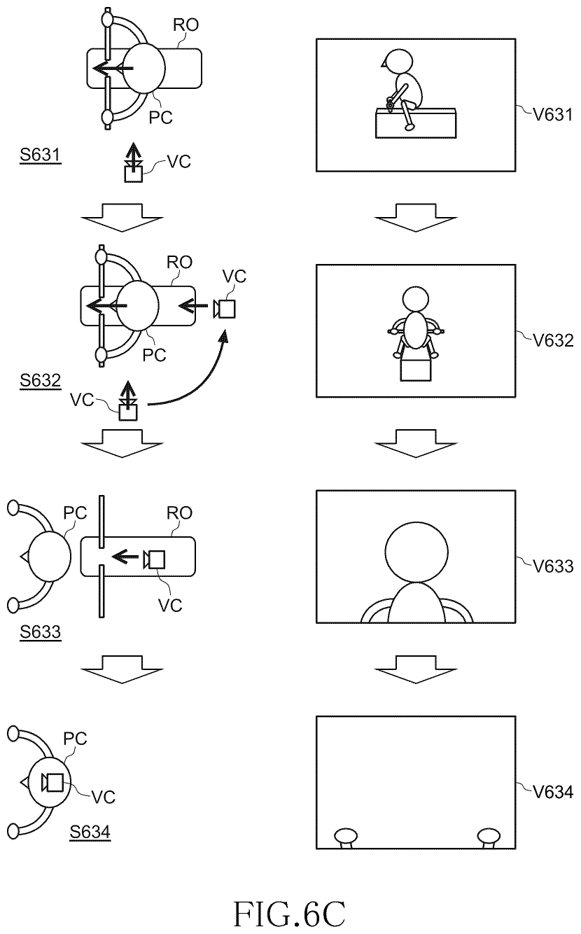

FIGS. 6A to 6B are transition diagrams illustrating the transition from the second mode to the first mode. In FIGS. 6A to 6B, the left side shows the transition of the game state and the right side shows the transition of the game image. In state S611 in FIG. 6A, the virtual camera VC is positioned behind the player character PC who is boarding the vehicle object RO. At this time, the image generation unit 117 generates, as the game image V611, the game image from the third person perspective in which the player character PC boarding the vehicle object RO is captured from behind.

In state S611, when the player presses the X button 304 to instruct the player character PC to disembark from the vehicle object RO, the player character control unit 114 causes the player character PC to start the action of disembarking the vehicle object RO. In state S612, in response to the instruction to disembark, the player character control unit 114 causes the player character PC to jump forward so that the player character PC jumps off the vehicle object RO toward its front. Along with this, the virtual camera control unit 113 moves the virtual camera VC toward the player character PC. As a result, the image generation unit 117 generates the game image V612 in which the player character PC jumps forward from the vehicle object RO.

In state S613, the virtual camera control unit 113 brings the virtual camera VC closer to the player character PC. The game image V613 is an example of the game image generated by the image generation unit 117 at this time.

In state S614, the virtual camera control unit 113 moves the virtual camera VC further and sets it at the same position as that of the player character PC. As a result, the image generation unit 117 generates the game image V614 from the first person perspective of the player character PC.

In the example in FIG. 6A, it was explained that the capturing direction of the virtual camera VC and the facing direction of the player character PC coincide when the disembark instruction is given, and therefore the direction of movement of the virtual camera VC when it approaches the player character PC and the facing direction of the player character PC and the virtual camera VC when the position of the virtual camera VC overlaps with the position of the player character PC (when the first person perspective is achieved) are in the same direction.

Referring to FIG. 6B, an example is described in which the capturing direction of the virtual camera VC and the facing direction of the player character PC do not match when a disembark instruction is given, and in which the movement direction of the virtual camera as it approaches the player character differs from the facing direction of the player character and the virtual camera when its position overlaps that of the player character (when the first person perspective is achieved).

In the example of FIG. 6B, in state S621, the virtual camera VC is capturing the player character PC boarding the vehicle object RO from the left side of the player character PC. The image generation unit 117 generates the game image V621 in which the player character PC boarding the vehicle object RO is captured from the left side.

In this embodiment, the player character control unit 114 sets the facing direction of the player character PC so that the facing direction of the player character PC follows the facing direction of the virtual camera VC when the player character PC disembarks from the vehicle object RO. After that, the player character PC disembarks from the vehicle object RO.

In state S621, when disembark is indicated, as shown in state S622, the player character control unit 114 cause the player character PC to jump in a direction of the facing direction of the virtual camera VC while setting the facing direction of the player character PC so that the facing direction of the player character PC (left direction in FIG. 6) is in line with the facing direction of the virtual camera VC (upper direction in FIG. 6). Along with this, the virtual camera control unit 113 moves the virtual camera VC toward the player character PC. As a result, the image generation unit 117 generates the game image V622 in which the player character PC jumps up toward the side of the vehicle object RO while changing its facing direction.

In state S623, the virtual camera control unit 113 brings the virtual camera VC closer to the player character PC. The game image V623 is an example of the game image generated by the image generation unit 117 at this time.

In state S624, the virtual camera control unit 113 moves the virtual camera VC further and sets it at the same position as that of the player character PC. As a result, the image generation unit 117 generates the game image V624 from the first person perspective of the player character PC.

In this way, as the game image V622 in which the player character PC jumps off the vehicle object while changing its facing direction to follow the facing direction of the virtual camera VC is shown when the disembark instruction is given, in the process of the game image changing from game image V623 to game image V624, the player can recognize that the direction in which the virtual camera VC approaches the player character PC is the same as the direction in which the player character PC is facing when the first person perspective is achieved, thus reducing the sense of discomfort caused by switching from the third person perspective to the first person perspective.

In the above embodiment, when a disembark instruction is received in the second mode, the mode is shifted to the first mode in which the player character PC is not boarding the vehicle object RO through the disembark action shown in FIGS. 6A to 6C. However, the disembark action is not limited to the above example. For example, the sequence of the above disembark action may be changed. This variation is explained below with reference to FIG. 6C.

In the example of FIG. 6C, in state S631, the virtual camera VC is capturing the player character PC boarding the vehicle object RO from the left side of the player character PC. The image generation unit 117 generates the game image V631 in which the player character PC boarding the vehicle object RO is captured from the left side.

In state S631, when the disembark instruction is given, as shown in state S632, the camera control unit 113 turns the virtual camera VC around the player object PC so that the facing direction of the virtual camera VC and the facing direction of the player character PC boarding the vehicle object RO are aligned and the virtual camera VC moves from that position to approach the player object PC. As a result, the image generation unit 117 generates the game image V633 in which the player character PC boarding the vehicle object RO is captured from behind.

Then, in state S623, the player character control unit 114 makes the player character PC jump so that the player character PC jumps toward the facing direction of the virtual camera VC (which is also the facing direction of the player character PC). In state S633, the virtual camera control unit 113 moves the virtual camera VC so that it approaches the player character PC. The game image V633 is an example of the game image generated by the image generation unit 117 at this time.

The virtual camera control unit 113 continues to approach the player character PC, and in state S634, the position of the virtual camera VC matches the position of the player character PC, and the image generation unit 117 generates the first person perspective game image V634.

Thus, in the example of FIG. 6B, when disembarking the player character PC from the vehicle object RO, the player character control unit 114 changes the facing direction of the player character PC so that it follows the facing direction of the virtual camera VC. In the example in FIG. 6C, when the player character PC disembarks from the vehicle object RO, the camera control unit 113 controls the facing direction of the virtual camera VC so that it follows the facing direction of the player character PC. In any case, the facing direction of the virtual camera VC and the facing direction of the player character PC are aligned when PC disembarks from the vehicle object RO.

When the disembark instruction is received, the mode may be switched from the first mode (first person perspective) to the second mode (third person perspective) without going through the disembark action as described above. At least part of the disembark action may be omitted as a process or may not be rendered.

### (Scanning in the Second Mode)

In the first and second modes, the player character control unit 114 causes the player character PC to execute scanning of a scannable object SO based on a scanning instruction when the scannable object SO is within the field of view of the virtual camera VC. In the second mode, during this scanning execution, the virtual camera control unit 113 sets the position and facing direction of the virtual camera VC so that the virtual camera VC, which provides a third person perspective, faces the scannable object SO.

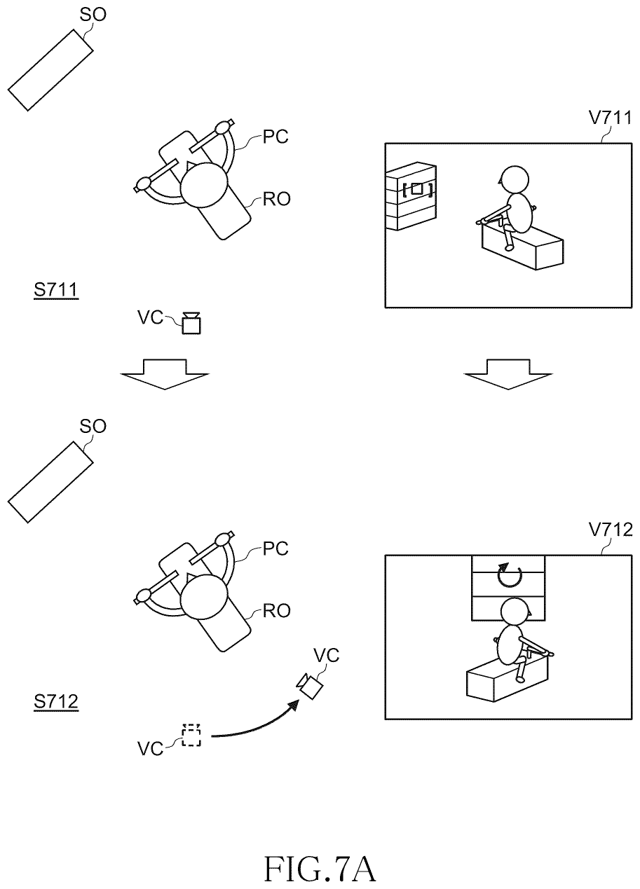

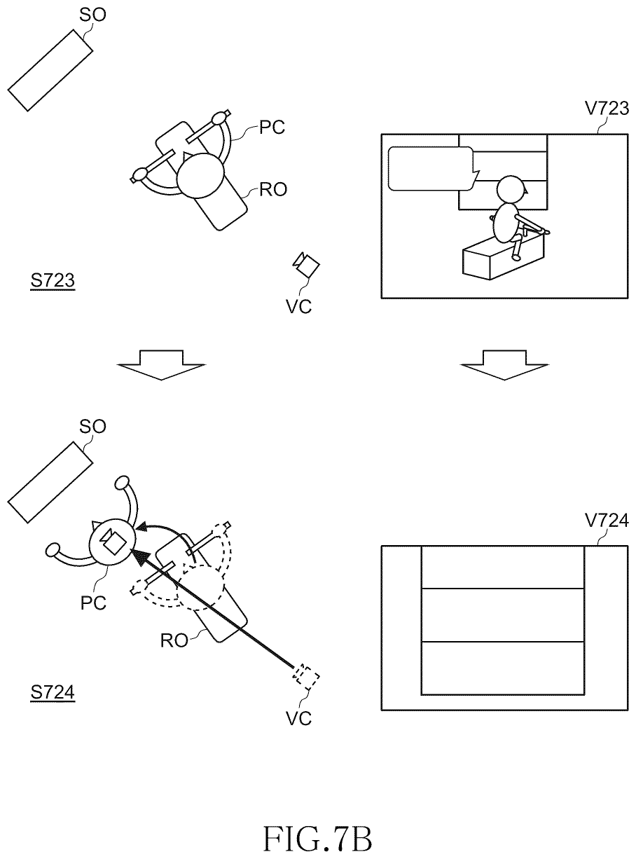

FIGS. 7A to 7B are transition diagrams illustrating scanning of a scannable object in the second mode. In FIGS. 7A to 7B, the left side shows the transition of the game state and the right side shows the transition of the game image. In state S711 in FIG. 7A, the virtual camera VC is positioned at the lower left of the player character PC boarding the vehicle object RO, and the scannable object SO is positioned at the upper left (front left from the player character's perspective) of the player character PC boarding the vehicle object RO.

At this time, the image generation unit 117 generates, as the game image V711, a game image from the third person perspective including the scannable object SO together with the player character PC boarding the vehicle object RO. The scannable object SO has a cursor superimposed on it indicating that it is a scannable object.

In this state, when the player gives the scanning instruction by pressing the A button 302 of the right controller 30, scanning of the scannable object on which the cursor is superimposed is started. At this time, the virtual camera control unit 113 sets the facing direction and position of the virtual camera VC to follow the direction from the player character PC to the scannable object, as shown in state S712.

When scanning starts, the image generation unit 117 generates a game image in which the scannable object SO is located behind the player character PC boarding the vehicle object RO, as shown in game image V712, and superimposes on the scannable object a mark indicating that it is being scanned. This mark may be an indicator of the progress of the scan.

State S721 in FIG. 7B indicates that scanning has been completed. The image generation unit 117 superimposes on the game image a dialog describing the result of scanning the scannable object SO in text. By reading this text, the player can learn what characteristics the scannable object SO has.

State S722 indicates that after reading the description of the scannable object SO, the player character PC is instructed to make the player character PC disembark from the vehicle object RO in order to perform further actions on the scannable object SO. As described above, when the player character disembarks, the player character control unit 114 controls the player character PC to jump off the vehicle object RO with the facing direction of the player character PC aligned with that of the virtual camera VC.

As shown in state 712 in FIG. 7A, the virtual camera VC is set in the direction and position along the direction from the player character PC to the scannable object SO at the start of the scan. As a result, the player character PC will jump off the vehicle object RO toward the scannable object SO from the vehicle object RO by the disembark instruction.

As a result, the scannable object SO exists in front of the player character PC when the player character PC changes to the first person perspective due to the disembarking of the player character PC from the vehicle object RO. At this time, the image generation unit 117 generates a game image showing the scannable object SO as the first person perspective game image V722. Therefore, after scanning the scannable object SO, the player can easily perform further actions on the scannable object that has already been scanned in the non-boarded state by giving the disembark instruction.

### (Shooting in the Second Mode)

In the first and second modes, the player character control unit 114 causes the player character PC to shoot based on a shooting instruction when there is an object to be shot within the field of view of the virtual camera VC. In the second mode, during this shooting, the virtual camera control unit 113 sets the position and facing direction of the virtual camera VC so that the virtual camera VC, which provides a third person perspective, faces the target object to be shot.

At this time, the virtual camera control unit 113 performs the same control for the virtual camera VC as during the scan execution described above. In other words, when shooting is indicated, the virtual camera control unit 113 sets the direction and position of the virtual camera VC so that it follows the direction from the player character PC toward the object to be shot.

### (Acceleration Charge in the Second Mode)

When the player character PC is boarding the vehicle object RO and approaches an acceleration charge object, the vehicle object control unit 115 causes the vehicle object RO to face a predetermined direction. In this embodiment, the acceleration charge object is an elevator object that ascends and descends. When the vehicle object RO on which the player character PC is boarding approaches the elevator, the vehicle object control unit 115 aligns the vehicle object RO with the facing direction of the virtual camera VC.

At this time, if the speed increase operation using the R button 308 is accepted, the vehicle object control unit 115 increases the speed parameter of the vehicle object RO. Note that this speed increase operation does not actually move the vehicle object RO on the spot.

When the value of the speed parameter exceeds a certain value, the game progression unit 111 changes the map structure of the virtual space. In this state, the vehicle object control unit 115 maintains the value of the increased speed parameter of the vehicle object RO, and in response to a movement instruction for the vehicle object RO, i.e., a directional input to the analog stick 301 of the right controller 30, the vehicle object control unit 115 moves the vehicle object RO in the virtual space with the speed increased in accordance with the speed parameter.

(Control of the Vehicle Object when Moving near a Wall in the Second Mode)

When the player character PC is boarding the vehicle object RO and moves so that it hits a wall placed in the virtual space, the vehicle object control unit 115 controls the movement of the vehicle object RO so that the vehicle object RO on which the player character PC is boarding moves along the wall. In other words, the vehicle object control unit 115 controls the movement of the vehicle object RO. In other words, even if the vehicle object RO hits a wall due to movement, the vehicle object control unit 115 does not stop the movement of the vehicle object RO as long as a directional input for movement is provided, but provides movement assist to move it along the wall.

For example, this movement assist is effective in a narrow area surrounded by walls. Since there is no such movement assist when the player object PC is not boarding the vehicle object RO, and such movement assist is performed when the player object PC is boarding the vehicle object RO, the player can select the appropriate means of movement from multiple means of movement (non-boarded/boarding) depending on the situation and move the player character PC.

### (Third Mode)

In the above embodiment, the first mode and the second mode are described as control modes, but further control modes different from the first mode and the second mode may be provided. For example, in the third mode, which is different from the first mode and the second mode, the player character control unit 114 transforms the player character PC into a spherical shape and makes it move in a rolling manner in the virtual space.

In the third mode, the virtual camera control unit 113 places the virtual camera VC in a different position from the player character PC, and the image generation unit 117 provides a third person perspective game image including the player character PC. In this third mode, the virtual camera control unit 113 does not control the virtual camera VC even by directional input to the analog stick 301 of the right controller 30, and the player character control unit 114 moves the player character PC according to the directional input to the analog stick 201 of the left controller 20. The position and facing direction of the virtual camera VC are automatically corrected as the player character PC moves. The user experience can be improved by enabling control of the virtual camera and player objects differently from the first and second modes.

1. A non-transitory computer-readable storage medium storing executable instructions that, when executed by one or more processors of an information processing device, cause the one or more processors to:
in a first mode,
control movement of a player character in a virtual space based on a first directional input;
control a position of a virtual camera according to a position of the player character;
control a facing direction of the player character in the virtual space based on the second directional input;
control a facing direction of the virtual camera to be in line with the facing direction of the player character; and
make the player character board a vehicle object based on a boarding instruction, and then switch to the second mode,
in the second mode,
control a facing direction of the vehicle object in the virtual space in which the player character is boarded based on a third directional input;
control the facing direction of the virtual camera in the virtual space based on a fourth directional input;
control a position of the virtual camera based on the facing direction of the virtual camera; and
make the player character disembark from the vehicle object based on a disembark instruction, and then switch to the first mode, wherein
when making the player character disembark from the vehicle object, set the facing direction of the player character to be in line with the facing direction of the virtual camera.

2. The non-transitory computer-readable storage medium according to claim 1, wherein the first directional input and the third directional input are inputs to the same input member.

3. The non-transitory computer-readable storage medium according to claim 1, wherein the second directional input and the fourth directional input are inputs to the same input member.

4. The non-transitory computer-readable storage medium according to claim 1, wherein the instructions, when executed by the one or more processors, cause the one or more processors to:
in the first mode, set a facing direction of the vehicle object in line with the direction of the first directional input when making the player character board the vehicle object based on the boarding instruction, in case that the first directional input is being made.

5. The non-transitory computer-readable storage medium according to claim 4, wherein the instructions, when executed by the one or more processors, cause the one or more processors to:
in the first mode, control the facing direction of the vehicle object in line with the facing direction of the player character when making the player character board the vehicle object based on the boarding instruction, in a case that the first directional input is not being made.

6. The non-transitory computer-readable storage medium according to claim 4, wherein the instructions, when executed by the one or more processors, cause the one or more processors to:
in the first mode,
bring the vehicle object closer to the player character in a direction based on the first directional input when making the player character board the vehicle object based on the boarding instruction; and
make the player character board the vehicle object when the vehicle object approaches the player character to a predetermined positional relationship.

7. The non-transitory computer-readable storage medium according to claim 4, wherein the instructions, when executed by the one or more processors, cause the one or more processors to:
in the second mode, make the player character disembark from the vehicle object after setting the facing direction of the player character in line with the facing direction of the virtual camera based on the disembark instruction.

8. The non-transitory computer-readable storage medium according to claim 1, wherein the instructions, when executed by the one or more processors, cause the one or more processors to:
in the second mode,
perform a scan of a scannable object based on a scan instruction when the scannable object is within a field of view of the virtual camera; and
set the facing direction of the virtual camera so that the virtual camera faces the scannable object when the scan is performed.

9. The non-transitory computer-readable storage medium according to claim 8, wherein the instructions, when executed by the one or more processors, cause the one or more processors to:
in the first mode,
perform a predetermined action on the scannable object based on an action instruction, wherein
the predetermined action is not executable in the second mode.

10. The non-transitory computer-readable storage medium according to claim 1, wherein the instructions, when executed by the one or more processors, cause the one or more processors to:
in the first mode, cause the virtual camera to acquire a first person perspective image by controlling the position of the virtual camera to be the same as the position of the player character.

11. The non-transitory computer-readable storage medium according to claim 1, wherein the instructions, when executed by the one or more processors, cause the one or more processors to:
in the second mode, cause the virtual camera to acquire a third person perspective image by controlling the position of the virtual camera to be different from the position of the player character.

12. The non-transitory computer-readable storage medium according to claim 1, wherein the instructions, when executed by the one or more processors, cause the one or more processors to:
in the first mode,
switch to a third mode based on a predetermined input, in the third mode,
control movement of the player character in the virtual space based on a fifth directional input, which is an input to the same input member as the first directional input;
control the facing direction of the player character based on a movement control of the player character; and
control the position and facing direction of the virtual camera based on the position of the player character.

13. An information processing system for executing a game in which a virtual space is provided, comprising one or more processors and a memory coupled thereto, the one or more processors being configured to control the information processing system to perform at least:
controlling a player character in the virtual space;
controlling a virtual camera;
controlling a vehicle object in the virtual space;
in the first mode,
controlling movement of the player character in the virtual space based on a first directional input, controlling a facing direction of the player character in the virtual space based on a second directional input, and making the player character board the vehicle object based on a boarding instruction;
controlling a position of the virtual camera based on a position of the player character and controlling a facing direction of the virtual camera to be in line with the facing direction of the player character; and
switching the first mode to the second mode after the player character is boarded on the vehicle object;
in the second mode,
controlling the facing direction of the vehicle object in the virtual space in which the player character is boarded based on a third directional input;
controlling the facing direction of the virtual camera in the virtual space based on the fourth directional input;
making the player character disembark from the vehicle object based on a disembark instruction; and
switching the second mode to the first mode after disembarking the player character from the vehicle object; and
the setting the facing direction of the player character to be in line with the facing direction of the virtual camera when making the player character disembark from the vehicle object.

14. The information processing system according to claim 13, wherein the first directional input and the third directional input are inputs to the same input member.

15. The information processing system according to claim 13, wherein the one or more processors are configured to control the information processing system to further perform:
in the first mode, setting a facing direction of the vehicle object in line with the direction of the first directional input when making the player character board the vehicle object based on the boarding instruction, in case that the first directional input is being made.

16. The information processing system according to claim 13, wherein the one or more processors are configured to control the information processing system to further perform:
in the second mode, making the player character disembark from the vehicle object after setting the facing direction of the player character in line with the facing direction of the virtual camera based on the disembark instruction.

17. An information processing method for executing a game in which a virtual space is provided, the information processing method executed using one or more processors, the method comprising:
in a first mode,
controlling movement of a player character in the virtual space based on a first directional input;
controlling a position of a virtual camera according to a position of the player character;
controlling a facing direction of the player character in the virtual space based on the second directional input;
controlling a facing direction of the virtual camera to be in line with the facing direction of the player character; and
making the player character board a vehicle object based on a boarding instruction, and then switching to the second mode,
in the second mode,
controlling a facing direction of the vehicle object in the virtual space in which the player character is boarded based on a third directional input;
controlling the facing direction of the virtual camera in the virtual space based on a fourth directional input;
controlling a position of the virtual camera based on the facing direction of the virtual camera; and
making the player character disembark from the vehicle object based on a disembark instruction, and then switching to the first mode, wherein
when making the player character disembark from the vehicle object, set the facing direction of the player character to be in line with the facing direction of the virtual camera.

18. The information processing method according to claim 17, wherein the first directional input and the third directional input are inputs to the same input member.

19. The information processing method according to claim 17, further comprising:
in the first mode, setting a facing direction of the vehicle object in line with the direction of the first directional input when making the player character board the vehicle object based on the boarding instruction, in case that the first directional input is being made.

20. The information processing method according to claim 17, further comprising:
in the second mode, making the player character disembark from the vehicle object after setting the facing direction of the player character in line with the facing direction of the virtual camera based on the disembark instruction.
